(19) United States
(12) Patent Application Publication
(10) Pub. No.: US 2023/0244547 A1
(43) Pub. Date: Aug. 3, 2023

(54) METHOD AND SYSTEM FOR ALLOCATING INFRASTRUCTURE RESOURCES IN CLOUD ENVIRONMENT

(71) Applicant: JPMorgan Chase Bank, N.A., New York, NY (US)

(72) Inventors: Shinoj Mathew, Hockessin, DE (US); Sharat Balagopalan, Iselin, NJ (US); Fahad Khawaja, New Castle, DE (US); Anand Sirvisetti, Kakinada (IN); Akram Hussain CHOUDHURY, Guwahati (IN)

(73) Assignee: JPMorgan Chase Bank, N.A., New York, NY (US)

(21) Appl. No.: 17/655,425

(22) Filed: Mar. 18, 2022

(30) Foreign Application Priority Data
Feb. 3, 2022 (IN) 202211005779

(51) Int. Cl. G06F 9/50

(52) U.S. Cl. CPC G06F 9/5083; G06F 9/5072; G06F 9/5077; G06F 9/5055; G06F 2209/505; G06F 2209/501

(57) ABSTRACT

A method for optimizing an allocation of infrastructure resources in a cloud environment based on supply and demand considerations with respect to computational capacity is provided. The method includes: receiving first information that relates to an initial number of jobs to be executed; determining, based on the first information, a number of clusters to be allocated for executing the jobs; provisioning the clusters such that each of the number of clusters is available for executing the jobs; receiving second information that relates to an updated number of jobs to be executed; adjusting, based on the second information, the number of clusters to be allocated; when the adjusting results in an increase in the number of clusters to be allocated, provisioning at least one additional cluster; and when the adjusting results in a decrease in the number of clusters to be allocated, deprovisioning at least one cluster.

### CROSS-REFERENCE TO RELATED APPLICATIONS

This application claims priority benefit from Indian Application No. 202211005779, filed Feb. 3, 2022, which is hereby incorporated by reference in its entirety.

### BACKGROUND

### 1. Field of the Disclosure

This technology generally relates to methods and systems for allocating computer resources, and more particularly to methods and systems for optimizing an allocation of infrastructure resources in a cloud environment based on supply and demand considerations with respect to computational capacity.

### 2. Background Information

Large organizations are often engaged in a variety of operations that require varying amounts of computational capacity. Such operations may be performed in a cloud environment in which compute cores and/or clusters are provisioned or allocated based on computational requirements.

Conventionally, compute clusters may be provisioned by allocating a set number of dedicated clusters to a particular user. However, this approach may result in excess computational capacity, which is costly and therefore translates into wasted financial resources. Alternatively, compute clusters may be provisioned on an “as-needed” basis, by which a minimum number of clusters is allocated to the particular user at any given time, and then, if an additional cluster becomes necessary, then the additional cluster is allocated when available. The cost of the as-needed approach may vary based on whether the particular user is willing to pay extra to ensure that an additional cluster is always available on demand, or whether the particular user is willing to accept a possible delay if an additional cluster is not available.

Accordingly, there is a need for a mechanism to optimize an allocation of infrastructure resources in a cloud environment based on supply and demand considerations with respect to computational capacity, so as to ensure availability while minimizing excess capacity so as to reduce cost.

### SUMMARY

The present disclosure, through one or more of its various aspects, embodiments, and/or specific features or sub-components, provides, inter alia, various systems, servers, devices, methods, media, programs, and platforms for optimizing an allocation of infrastructure resources in a cloud environment based on supply and demand considerations with respect to computational capacity.

According to an aspect of the present disclosure, a method for allocating resources in a cloud environment is provided. The method is implemented by at least one processor. The method includes: receiving, by the at least one processor, first information that relates to an initial number of jobs to be executed; determining, by the at least one processor based on the first information, a number of clusters to be allocated for executing the initial number of jobs; provisioning, by the at least one processor, the clusters such that each of the number of clusters is available for executing the initial number of jobs; receiving, by the at least one processor, second information that relates to an updated number of jobs to be executed; adjusting, by the at least one processor based on the second information, the number of clusters to be allocated; when the adjusting results in an increase in the number of clusters to be allocated, provisioning, by the at least one processor, at least one additional cluster such that each of the adjusted number of clusters is available for executing the updated number of jobs; and when the adjusting results in a decrease in the number of clusters to be allocated, deprovisioning at least one cluster from among the provisioned clusters such that the deprovisioned at least one cluster is not being used to execute the updated number of jobs.

The determining of the number of clusters to be allocated and the adjusting of the number of clusters to be allocated may be performed by applying a demand-versus-supply algorithm that uses the first information and the second information as inputs.

The receiving of the second information may be performed periodically based on a predetermined time interval.

The predetermined time interval may include at least one from among 60 minutes, 30 minutes, 10 minutes, 5 minutes, and 2 minutes.

The provisioning of the clusters may include provisioning each cluster from an Amazon Elastic MapReduce (EMR) cloud platform.

The determining of the number of clusters to be allocated may include using the first information to determine i) an initial number of calculations per second that corresponds to the executing of the initial number of jobs and ii) an initial number of parallel processing operations that corresponds to the executing of the initial number of jobs.

The adjusting of the number of clusters to be allocated may include using the second information to determine i) an updated number of calculations per second that corresponds to the executing of the updated number of jobs and ii) an updated number of parallel processing operations that corresponds to the executing of the updated number of jobs.

The method may further include displaying a graphical user interface that includes at least one prompt for facilitating a user input that corresponds to at least one from among the first information and the second information.

At least one from among the first information and the second information may include service level agreement (SLA) information that relates to the number of clusters to be allocated.

According to another aspect of the present disclosure, a computing apparatus for allocating resources in a cloud environment is provided. The computing apparatus includes a processor; a memory; and a communication interface coupled to each of the processor and the memory. The processor is configured to: receive, via the communication interface, first information that relates to an initial number of jobs to be executed; determine, based on the first information, a number of clusters to be allocated for executing the initial number of jobs; provision the clusters such that each of the number of clusters is available for executing the initial number of jobs; receive, via the communication interface, second information that relates to an updated number of jobs to be executed; adjust, based on the second information, the number of clusters to be allocated; when the adjustment results in an increase in the number of clusters to be allocated, provision at least one additional cluster such that each of the adjusted number of clusters is available for executing the updated number of jobs; and when the adjustment results in a decrease in the number of clusters to be allocated, deprovision at least one cluster from among the provisioned clusters such that the deprovisioned at least one cluster is not being used to execute the updated number of jobs.

The determination of the number of clusters to be allocated and the adjustment of the number of clusters to be allocated may be performed by applying a demand-versus-supply algorithm that uses the first information and the second information as inputs.

The processor may be further configured to receive the second information periodically based on a predetermined time interval.

The predetermined time interval may include at least one from among 60 minutes, 30 minutes, 10 minutes, 5 minutes, and 2 minutes.

The processor may be further configured to provision the clusters by provisioning each cluster from an Amazon Elastic MapReduce (EMR) cloud platform.

The processor may be further configured to determine the number of clusters to be allocated by using the first information to determine i) an initial number of calculations per second that corresponds to the executing of the initial number of jobs and ii) an initial number of parallel processing operations that corresponds to the executing of the initial number of jobs.

The processor may be further configured to adjust the number of clusters to be allocated by using the second information to determine i) an updated number of calculations per second that corresponds to the executing of the updated number of jobs and ii) an updated number of parallel processing operations that corresponds to the executing of the updated number of jobs.

The processor may be further configured to display, on a display, a graphical user interface that includes at least one prompt for facilitating a user input that corresponds to at least one from among the first information and the second information.

At least one from among the first information and the second information may include service level agreement (SLA) information that relates to the number of clusters to be allocated.

According to yet another aspect of the present disclosure, a non-transitory computer readable storage medium storing instructions for allocating resources in a cloud environment is provided. The storage medium includes executable code which, when executed by a processor, causes the processor to: receive first information that relates to an initial number of jobs to be executed; determine, based on the first information, a number of clusters to be allocated for executing the initial number of jobs; provision the clusters such that each of the number of clusters is available for executing the initial number of jobs; receive second information that relates to an updated number of jobs to be executed; adjust, based on the second information, the number of clusters to be allocated; when the adjustment results in an increase in the number of clusters to be allocated, provision at least one additional cluster such that each of the adjusted number of clusters is available for executing the updated number of jobs; and when the adjustment results in a decrease in the number of clusters to be allocated, deprovision at least one cluster from among the provisioned clusters such that the deprovisioned at least one cluster is not being used to execute the updated number of jobs.

The executable code may be further configured to cause the processor to perform each of the determination of the number of clusters to be allocated and the adjustment of the number of clusters to be allocated by applying a demand-versus-supply algorithm that uses the first information and the second information as inputs.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for optimizing an allocation of infrastructure resources in a cloud environment based on supply and demand considerations with respect to computational capacity.

FIG. 4 is a flowchart of an exemplary process for implementing a method for optimizing an allocation of infrastructure resources in a cloud environment based on supply and demand considerations with respect to computational capacity.

FIG. 5 is a data flow diagram that illustrates a system and method for optimizing an allocation of infrastructure resources in a cloud environment based on supply and demand considerations with respect to computational capacity, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

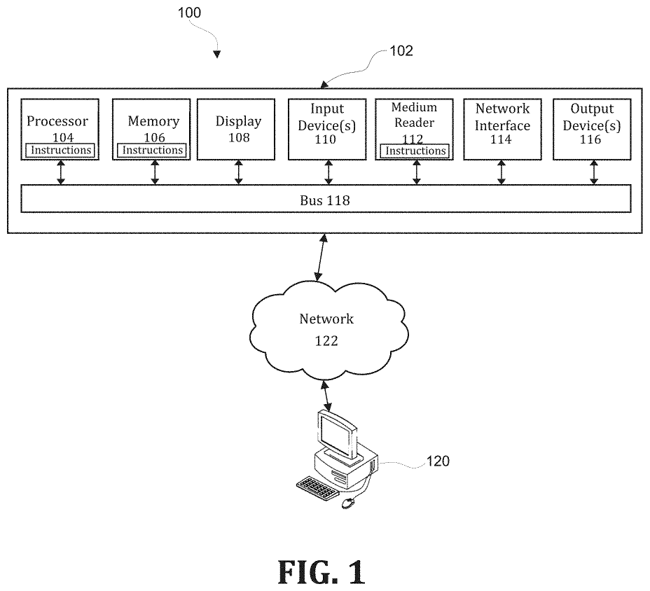

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for optimizing an allocation of infrastructure resources in a cloud environment based on supply and demand considerations with respect to computational capacity.

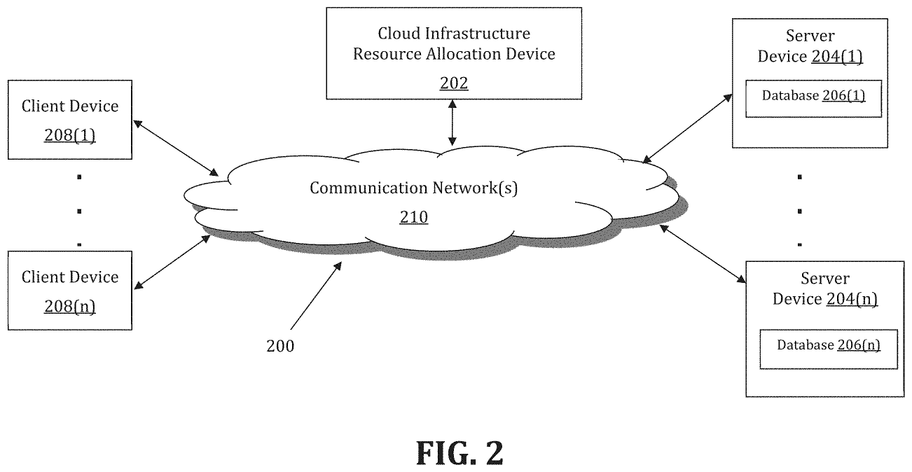

Referring to FIG. 2, a schematic of an exemplary network environment 200 for implementing a method for optimizing an allocation of infrastructure resources in a cloud environment based on supply and demand considerations with respect to computational capacity is illustrated. In an exemplary embodiment, the method is executable on any networked computer platform, such as, for example, a personal computer (PC).

The method for optimizing an allocation of infrastructure resources in a cloud environment based on supply and demand considerations with respect to computational capacity may be implemented by a Cloud Infrastructure Resource Allocation (CIRA) device 202. The CIRA device 202 may be the same or similar to the computer system 102 as described with respect to FIG. 1. The CIRA device 202 may store one or more applications that can include executable instructions that, when executed by the CIRA device 202, cause the CIRA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CIRA device 202 itself, may be located in virtual server(s) running in a cloud-based computing environment rather than being tied to one or more specific physical network computing devices. Also, the application(s) may be running in one or more virtual machines (VMs) executing on the CIRA device 202. Additionally, in one or more embodiments of this technology, virtual machine(s) running on the CIRA device 202 may be managed or supervised by a hypervisor.

In the network environment 200 of FIG. 2, the CIRA device 202 is coupled to a plurality of server devices 204(1)-204(n) that hosts a plurality of databases 206(1)-206(n), and also to a plurality of client devices 208(1)-208(n) via communication network(s) 210. A communication interface of the CIRA device 202, such as the network interface 114 of the computer system 102 of FIG. 1, operatively couples and communicates between the CIRA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CIRA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CIRA devices that efficiently implement a method for optimizing an allocation of infrastructure resources in a cloud environment based on supply and demand considerations with respect to computational capacity.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CIRA device 202 may be a standalone device or integrated with one or more other devices or apparatuses, such as one or more of the server devices 204(1)-204(n), for example. In one particular example, the CIRA device 202 may include or be hosted by one of the server devices 204(1)-204(n), and other arrangements are also possible. Moreover, one or more of the devices of the CIRA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CIRA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to application-specific computational requirements and data that relates to cloud infrastructure resources.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CIRA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CIRA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CIRA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CIRA device 202, the server devices 204(1)-204(n), or the client devices 208(1)-208(n), for example, may be configured to operate as virtual instances on the same physical machine. In other words, one or more of the CIRA device 202, the server devices 204(1)-204(n), or the client devices 208(1)-208(n) may operate on the same physical device rather than as separate devices communicating through communication network(s) 210. Additionally, there may be more or fewer CIRA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

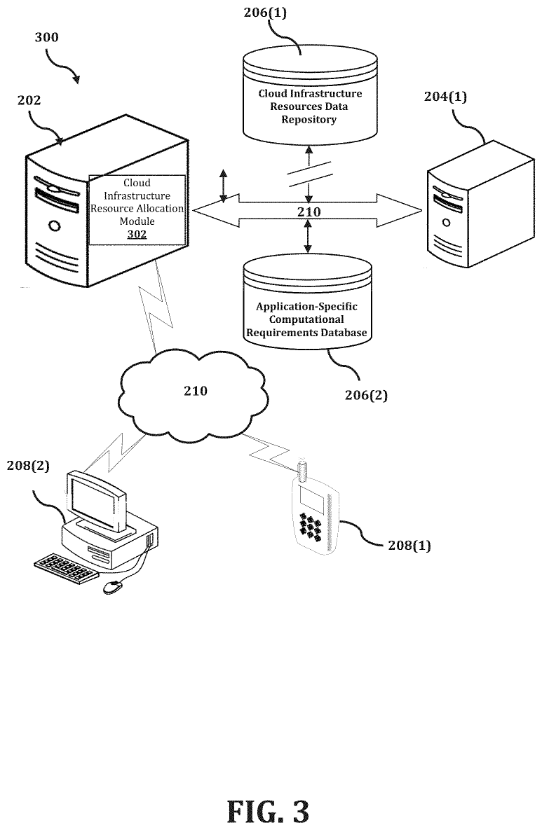

The CIRA device 202 is described and illustrated in FIG. 3 as including a cloud infrastructure resource allocation module 302, although it may include other rules, policies, modules, databases, or applications, for example. As will be described below, the cloud infrastructure resource allocation module 302 is configured to implement a method for optimizing an allocation of infrastructure resources in a cloud environment based on supply and demand considerations with respect to computational capacity.

An exemplary process 300 for implementing a mechanism for optimizing an allocation of infrastructure resources in a cloud environment based on supply and demand considerations with respect to computational capacity by utilizing the network environment of FIG. 2 is illustrated as being executed in FIG. 3. Specifically, a first client device 208(1) and a second client device 208(2) are illustrated as being in communication with CIRA device 202. In this regard, the first client device 208(1) and the second client device 208(2) may be “clients” of the CIRA device 202 and are described herein as such. Nevertheless, it is to be known and understood that the first client device 208(1) and/or the second client device 208(2) need not necessarily be “clients” of the CIRA device 202, or any entity described in association therewith herein. Any additional or alternative relationship may exist between either or both of the first client device 208(1) and the second client device 208(2) and the CIRA device 202, or no relationship may exist.

Further, CIRA device 202 is illustrated as being able to access a cloud infrastructure resources data repository 206(1) and an application-specific computational requirements database 206(2). The cloud infrastructure resource allocation module 302 may be configured to access these databases for implementing a method for optimizing an allocation of infrastructure resources in a cloud environment based on supply and demand considerations with respect to computational capacity.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CIRA device 202 via broadband or cellular communication. Of course, these embodiments are merely exemplary and are not limiting or exhaustive.

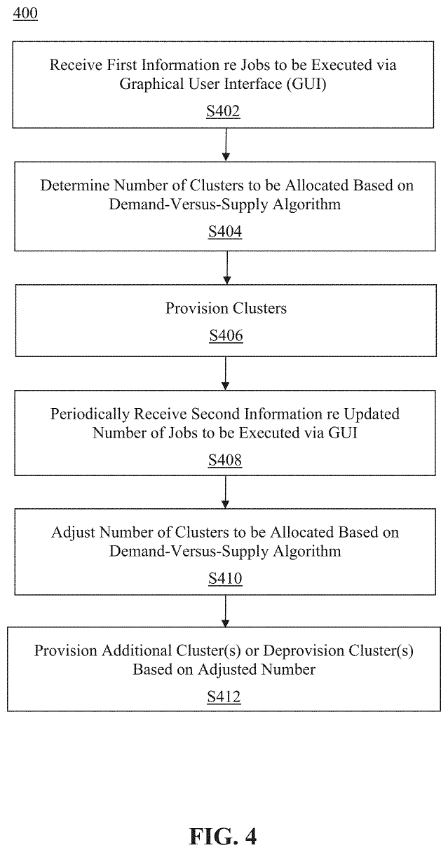

Upon being started, the cloud infrastructure resource allocation module 302 executes a process for optimizing an allocation of infrastructure resources in a cloud environment based on supply and demand considerations with respect to computational capacity. An exemplary process for optimizing an allocation of infrastructure resources in a cloud environment based on supply and demand considerations with respect to computational capacity is generally indicated at flowchart 400 in FIG. 4.

In process 400 of FIG. 4, at step S402, the cloud infrastructure resource allocation module 302 receives first information that relates to a set of jobs to be executed. In an exemplary embodiment, the first information is received via a graphical user interface (GUI) that includes prompts for facilitating user inputs to specify the first information. The first information may include, for example, information about which applications are being utilized for each job, a number of jobs to be executed, a required number of calculations per second for each job to be executed, and information relating to a number and/or volume of parallel processing operations that correspond to the jobs to be executed.

At step S404, the cloud infrastructure resource allocation module 302 determines a number of clusters to be allocated for executing the jobs to be executed as indicated by the first information. Then, at step S406, the cloud infrastructure resource allocation module 302 provisions the clusters. In an exemplary embodiment, the clusters are provisioned from a public cloud platform, such as, for example, an Amazon Web Services (AWS) Elastic MapReduce (EMR) cloud platform. The determination of the number of clusters to be allocated and/or the provisioning of the clusters may also be affected by service level agreement (SLA) information that is included in the first information. In an exemplary embodiment, the determination of the number of clusters to be allocated may be performed by applying a demand-versus-supply algorithm that uses the first information as an input.

In an exemplary embodiment, the determination of the number of clusters to be allocated may also take cost and accessibility considerations into account. For example, a public cloud platform may offer varying accessibility levels to each cluster, i.e., dedicated clusters that are dedicated solely to operations being executed by a particular user; “on-demand” clusters that are made available only when requested, but are guaranteed to be available at any time; and clusters that are made available only when requested and when not already in use by another user (hereinafter referred to as “regular” clusters). For each accessibility level, there is a cost tradeoff—i.e., dedicated clusters are the most expensive, and an on-demand cluster is more expensive than a cluster for which the user may be required to wait until it becomes available.

At step S408, the cloud infrastructure resource allocation module 302 receives second information that relates to an updated set of jobs to be executed. In an exemplary embodiment, similarly as the first information, the second information may be received via the GUI that includes prompts for facilitating user inputs to specify the second information. The second information may include, for example, information about which applications are being utilized for each job included in the updated set of jobs, an adjusted number of jobs to be executed, a required number of calculations per second for each job to be executed, and information relating to a number and/or volume of parallel processing operations that correspond to the jobs to be executed. In an exemplary embodiment, the second information may be received on a periodic basis that occurs on a predetermined time interval, such as, for example, every hour (i.e., every 60 minutes), every 30 minutes, every 10 minutes, every 5 minutes, every 2 minutes, every 60 seconds, and/or any other suitable interval.

At step S410, the cloud infrastructure resource allocation module 302 determines an adjusted number of clusters to be allocated for executing the updated set of jobs to be executed as indicated by the second information. Then, at step S412, the cloud infrastructure resource allocation module 302 adjusts the provisioning of the clusters based on the adjusted number by either provisioning additional clusters or deprovisioning at least one cluster. The determination of the adjusted number of clusters to be allocated and/or the provisioning or deprovisioning of the clusters may also be affected by service level agreement (SLA) information that is included in the second information.

In an exemplary embodiment, the determination of the adjusted number of clusters to be allocated may be performed by applying the demand-versus-supply algorithm while using uses the second information as an input. In an exemplary embodiment, similarly as with the first information, the determination of the adjusted number of clusters to be allocated may also take cost and accessibility considerations into account with respect to the types of clusters being provisioned, i.e., dedicated clusters, on-demand clusters, and/or regular clusters.

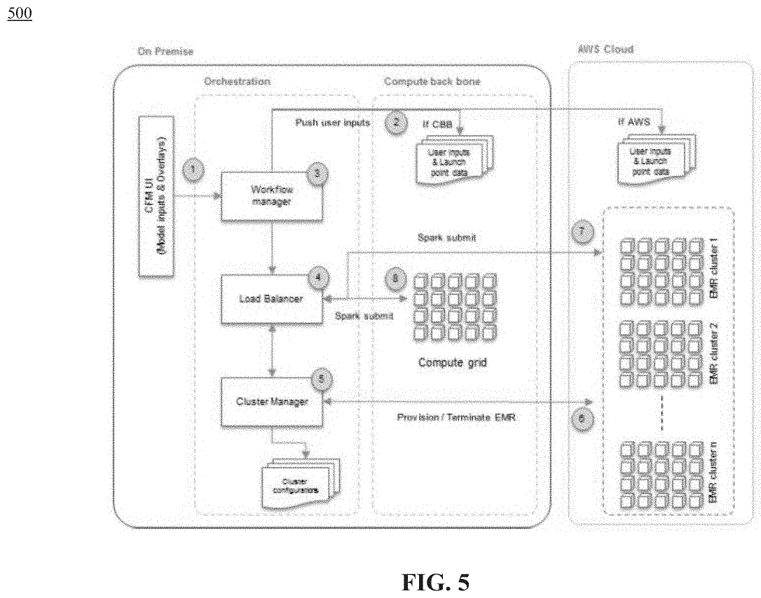

FIG. 5 is a data flow diagram 500 that illustrates a system and method for optimizing an allocation of infrastructure resources in a cloud environment based on supply and demand considerations with respect to computational capacity, according to an exemplary embodiment. As shown in data flow diagram 500, there is a compute back bone (CBB) that is hosted on premise and is accessible for executing some tasks based on available computational capacity, and there is also an AWS EMR public cloud platform that provides available clusters for provisioning.

As illustrated in data flow diagram, in a first operation 1, a user leverages a card forecasting model (CFM) user interface (UI) to provide inputs for an initial set of jobs to be executed. The user may also specify whether each job is to be executed on the CBB or on the AWS cloud. In a second operation 2, a workflow manager routes each job to the appropriate platform for execution. In a third operation 3, each job is sent to a load balancer for making determinations with respect to computational capacity that is required to executing the jobs.

In a fourth operation 4, the load balancer sends a request to a cluster manage to request a provisioning of an EMR cluster for executing the workload. In a fifth operation 5, the cluster manager attempts to identify an EMR cluster that has a suitable configuration for the requested workload. In a sixth operation 6, the cluster manager tracks all available EMR clusters and periodically monitors health and utilization of the clusters. A new cluster is provisioned when demand arises. If a particular cluster is idle for a period of time that exceeds a predetermined threshold, then the cluster manage may deprovision that cluster for cost optimization.

In a seventh operation 7, once an EMR cluster has been made available to the load balancer, a spark job is submitted to the newly available cluster for execution. When this job is completed, the load balancer releases the cluster back to the cluster manager and updates the workflow manager with respect to execution status.

In an eighth operation 8, the load balancer sends a request to the compute back bone (CBB) for execution of the corresponding workload. In this regard, the load balancer limits the number of concurrent tasks being executed on the CBB due to limited computational capacity. When the corresponding job is completed, the load balancer updates the workflow manager with respect to execution status.

Accordingly, with this technology, an optimized process for optimizing an allocation of infrastructure resources in a cloud environment based on supply and demand considerations with respect to computational capacity is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for allocating resources in a cloud environment, the method being implemented by at least one processor, the method comprising:
receiving, by the at least one processor, first information that relates to an initial number of jobs to be executed;
determining, by the at least one processor based on the first information, a number of clusters to be allocated for executing the initial number of jobs;
provisioning, by the at least one processor, the clusters such that each of the number of clusters is available for executing the initial number of jobs;
receiving, by the at least one processor, second information that relates to an updated number of jobs to be executed;
adjusting, by the at least one processor based on the second information, the number of clusters to be allocated;
when the adjusting results in an increase in the number of clusters to be allocated, provisioning, by the at least one processor, at least one additional cluster such that each of the adjusted number of clusters is available for executing the updated number of jobs; and
when the adjusting results in a decrease in the number of clusters to be allocated, deprovisioning at least one cluster from among the provisioned clusters such that the deprovisioned at least one cluster is not being used to execute the updated number of jobs.

2. The method of claim 1, wherein the determining of the number of clusters to be allocated and the adjusting of the number of clusters to be allocated are performed by applying a demand-versus-supply algorithm that uses the first information and the second information as inputs.

3. The method of claim 1, wherein the receiving of the second information is performed periodically based on a predetermined time interval.

4. The method of claim 3, wherein the predetermined time interval includes at least one from among 60 minutes, 30 minutes, 10 minutes, 5 minutes, and 2 minutes.

5. The method of claim 1, wherein the provisioning of the clusters comprises provisioning each cluster from an Amazon Elastic MapReduce (EMR) cloud platform.

6. The method of claim 1, wherein the determining of the number of clusters to be allocated comprises using the first information to determine i) an initial number of calculations per second that corresponds to the executing of the initial number of jobs and ii) an initial number of parallel processing operations that corresponds to the executing of the initial number of jobs.

7. The method of claim 1, wherein the adjusting of the number of clusters to be allocated comprises using the second information to determine i) an updated number of calculations per second that corresponds to the executing of the updated number of jobs and ii) an updated number of parallel processing operations that corresponds to the executing of the updated number of jobs.

8. The method of claim 1, further comprising displaying a graphical user interface that includes at least one prompt for facilitating a user input that corresponds to at least one from among the first information and the second information.

9. The method of claim 1, wherein at least one from among the first information and the second information includes service level agreement (SLA) information that relates to the number of clusters to be allocated.

10. A computing apparatus for allocating resources in a cloud environment, the computing apparatus comprising:
a processor;
a memory; and
a communication interface coupled to each of the processor and the memory,
wherein the processor is configured to:
receive, via the communication interface, first information that relates to an initial number of jobs to be executed;
determine, based on the first information, a number of clusters to be allocated for executing the initial number of jobs;
provision the clusters such that each of the number of clusters is available for executing the initial number of jobs;
receive, via the communication interface, second information that relates to an updated number of jobs to be executed;
adjust, based on the second information, the number of clusters to be allocated;
when the adjustment results in an increase in the number of clusters to be allocated, provision at least one additional cluster such that each of the adjusted number of clusters is available for executing the updated number of jobs; and
when the adjustment results in a decrease in the number of clusters to be allocated, deprovision at least one cluster from among the provisioned clusters such that the deprovisioned at least one cluster is not being used to execute the updated number of jobs.

11. The computing apparatus of claim 10, wherein the determination of the number of clusters to be allocated and the adjustment of the number of clusters to be allocated are performed by applying a demand-versus-supply algorithm that uses the first information and the second information as inputs.

12. The computing apparatus of claim 10, wherein the processor is further configured to receive the second information periodically based on a predetermined time interval.

13. The computing apparatus of claim 12, wherein the predetermined time interval includes at least one from among 60 minutes, 30 minutes, 10 minutes, 5 minutes, and 2 minutes.

14. The computing apparatus of claim 10, wherein the processor is further configured to provision the clusters by provisioning each cluster from an Amazon Elastic MapReduce (EMR) cloud platform.

15. The computing apparatus of claim 10, wherein the processor is further configured to determine the number of clusters to be allocated by using the first information to determine i) an initial number of calculations per second that corresponds to the executing of the initial number of jobs and ii) an initial number of parallel processing operations that corresponds to the executing of the initial number of jobs.

16. The computing apparatus of claim 10, wherein the processor is further configured to adjust the number of clusters to be allocated by using the second information to determine i) an updated number of calculations per second that corresponds to the executing of the updated number of jobs and ii) an updated number of parallel processing operations that corresponds to the executing of the updated number of jobs.

17. The computing apparatus of claim 10, wherein the processor is further configured to display, on a display, a graphical user interface that includes at least one prompt for facilitating a user input that corresponds to at least one from among the first information and the second information.

18. The computing apparatus of claim 10, wherein at least one from among the first information and the second information includes service level agreement (SLA) information that relates to the number of clusters to be allocated.

19. A non-transitory computer readable storage medium storing instructions for allocating resources in a cloud environment, the storage medium comprising executable code which, when executed by a processor, causes the processor to:
receive first information that relates to an initial number of jobs to be executed;
determine, based on the first information, a number of clusters to be allocated for executing the initial number of jobs;
provision the clusters such that each of the number of clusters is available for executing the initial number of jobs;
receive second information that relates to an updated number of jobs to be executed;
adjust, based on the second information, the number of clusters to be allocated;
when the adjustment results in an increase in the number of clusters to be allocated, provision at least one additional cluster such that each of the adjusted number of clusters is available for executing the updated number of jobs; and
when the adjustment results in a decrease in the number of clusters to be allocated, deprovision at least one cluster from among the provisioned clusters such that the deprovisioned at least one cluster is not being used to execute the updated number of jobs.

20. The storage medium of claim 19, wherein the executable code is further configured to cause the processor to perform each of the determination of the number of clusters to be allocated and the adjustment of the number of clusters to be allocated by applying a demand-versus-supply algorithm that uses the first information and the second information as inputs.
